(19) United States
(12) Patent Application Publication
(10) Pub. No.: US 2003/0097261 A1
(43) Pub. Date: May 22, 2003

(54) Speech detection apparatus under noise environment and method thereof

(76) Inventors: Hyung-Bae Jeon, Seoul (KR); Ho-Young Jung, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/074,451

(22) Filed: Feb. 11, 2002

(30) Foreign Application Priority Data
Nov. 22, 2001 (KR) 01-73007

(51) Int. Cl. G10L 15/20

(52) U.S. Cl. 704/233

(57) ABSTRACT

A speech detection apparatus using basis functions, which are trained by independent component analysis (ICA) and method thereof are provided. The speech detection method includes the steps of training basis functions of speech signals and basis functions of noise signals according to a predetermined learning rule, adapting the basis functions of noise signals to the present environment by using the characteristic of noise signals, which are input into a mike, extracting determination information for detection speech activation from the basis functions of speech signals and the basis functions of noise signals, and detecting a speech starting point and a speech ending point of mike signals, which are come into a speech recognition unit, from the determination information.

### BACKGROUND OF THE INVENTION

1. Field of the Invention

The present invention relates to a speech detection apparatus and method thereof, and more particularly, to a speech detection apparatus using basis functions, which are trained by independent component analysis (ICA), and a method thereof.

2. Description of the Related Art

In general, speech recognition is a technology in which speech signals input into a mike are recognized by a computer and converted into a signal format in which human being can recognize. Since driving a speech recognition module in a speech recognition system requires a high cost such as a large capacity memory, the speech recognition module should be operated at a time where speech begins. Thus, a speech boundary detection apparatus is necessary in the speech recognition system. Further, a speech boundary detection method should be implemented robustly in an actual noise environment and should be implemented with small computation at a real time so as to be used in a real-time speech recognition unit. A conventional speech boundary detection apparatus uses information such as energy components of speech signals, frequency spectrums, and zero-crossing rates. However, when circumferential noise is mixed with speech signals, the characteristics of speech signals are damaged by noise, and thus detection of a speech boundary becomes difficult. Thus, in a conventional speech boundary detection method, accuracy of voice activation detection is lowered clearly in a heavy noise environment with a low signal-to-noise ratio (SNR), and a false alarm rate, misjudging mute as speech, increases accordingly.

### SUMMARY OF THE INVENTION

To solve the above problems, it is a first object of the present invention to provide a speech detection method which IS capable of learning basis functions of speech signals and noise signals by using independent component analysis (ICA) and detecting a stable speech boundary even in a high noise environment with a low signal-to-noise ratio (SNR) by using the learned basis functions.

It is a second object of the present invention to provide a speech detection apparatus used by the speech detection method.

Accordingly, to achieve the first object, there is provided a speech detection method in a noise environment. The method includes the steps of training basis functions of speech signals and basis functions of noise signals according to a predetermined learning rule, adapting the basis functions of noise signals to the present environment by using the characteristic of noise signals, which are input into a mike, extracting determination information of a speech boundary from the basis functions of speech signals and the basis functions of noise signals, and detecting a speech starting point and a speech ending point of mike signals, which are input into a speech recognition unit, from the determination information.

To achieve the second object, there is provided a speech detection apparatus for detecting a speech boundary in a noise environment. The apparatus includes a learning network means, which trains basis functions of speech signals and basis functions of noise signals according to a predetermined learning rule and adapts the basis functions of noise signals to the present environment by using the characteristic of noise signals, which input into a mike, a determination information-extracting means, which extracts determination information of a speech boundary from the basis functions of speech signals and the basis functions of noise signals, and a speech boundary-determining means, which detects a speech starting point and a speech ending point of mike signals, which are input into a speech recognition unit, using the determination information of speech signal

### BRIEF DESCRIPTION OF THE DRAWINGS

The above objects and advantages of the present invention will become more apparent by describing in detail a preferred embodiment thereof with reference to the attached drawings in which:

FIG. 1 illustrates the structure of speech signals, which are linearly combined with basis functions;

FIG. 2 illustrates the concept of an independent component analysis (ICA) network, which trains basis functions by using speech signals;

FIG. 3 is a block diagram of a speech detection apparatus according to the present invention;

FIG. 4 is a detailed diagram of a determination information-extracting module of FIG. 3;

FIG. 5 illustrates state transition in which start and end of speech are determined using determination information extracted from the determination information-extracting module; and

FIG. 6 is a flow chart illustrating a speech detection method according to the present invention.

### DETAILED DESCRIPTION OF THE INVENTION

Hereinafter, the present invention will be described in detail by describing preferred embodiments of the invention with reference to the accompanying drawings.

According to the present invention, basis functions of speech signals and noise signals are used so as to detect a speech boundary, which is robust to noise. The basis functions are components composing speech signals or noise signals. Thus, the characteristics of speech signals and noise signals, that is, the characteristics of frequency, are included in the basis functions. Using the characteristics of the basis functions, a relative energy ratio of noise to speech can be obtained from noise-mixed speech signals.

Independent component analysis (ICA) is used for obtaining the basis functions of speech signals and noise signals. The independent component (ICA) analysis is a method for searching signals before mixing and mixing matrix only on a condition that mixed signals are collected from a mike and original signals are statistically independent.

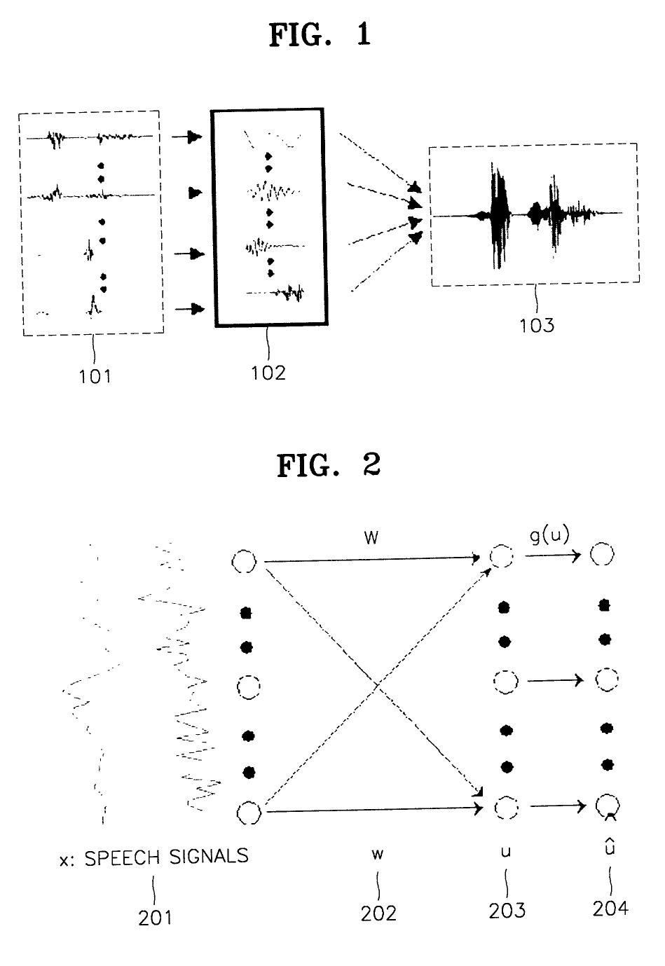

FIG. 1 illustrates the structure of speech signals, which are linearly combined with basis functions. Referring to FIG. 1, when speech signal is x, speech signals 103 are constituted by a mixing matrix A containing a generation coefficient 101 and basis functions 102 using Equation 1.

x=As [Equation 1]

Here, s is a generation coefficient, and row vectors of the mixing matrix A become basis functions 102 of the speech signals 103. The basis functions 102 of the speech signals 103, which are obtained by the ICA, are represented as waveforms, which respond to each of specific frequency components.

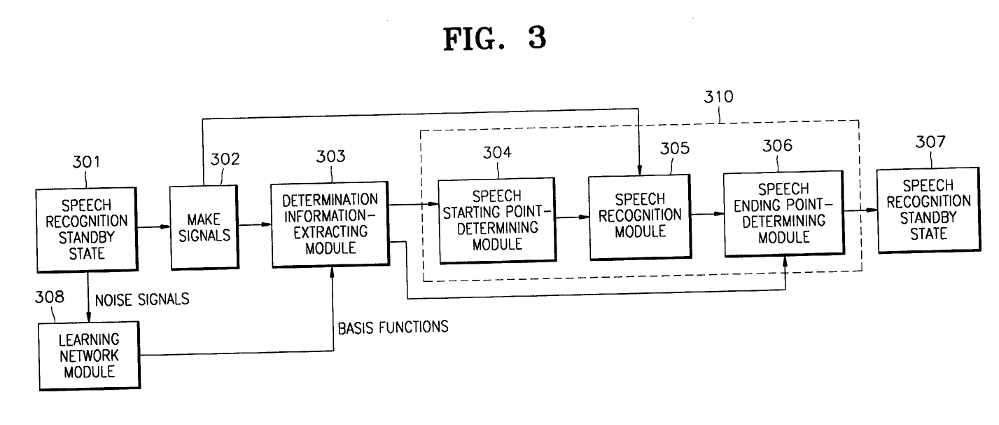

FIG. 2 illustrates the concept of an independent component analysis (ICA) network, which trains basis functions by using speech signals. Referring to FIG. 2, a learning network of the ICA trains basis functions by using large quantity of speech signals as learning data, using Equation 2.

$$Δ W ∝ \frac{\partial H ( \hat{u} )}{\partial W} {W}^{T} W = [ I - ϕ ( u ) {u}^{T} ] W \qquad [ Equation 2 ]$$

When an unmixing matrix W 202 is learned according to a learning rule such as the ICA of Equation 2, an output signal u 203 of a network W becomes a series of signals (u), which is statistically independent. The signal (u) is a series of signals, which are estimations of independent generation coefficient s from speech signals 201. By performing the learning step repeatedly, the matrix W 202 is learned until convergence. After convergence row vectors of A, a reverse matrix of the matrix W 202, become basis functions.

Basis functions of noise signals can be also learned by the same method as that of speech signals.

Basis functions of speech signals and noise signals should be previously learned by using speech signals, which are sufficient for speech detection, and various noise signals.

FIG. 3 is a block diagram of a speech detection apparatus according to the present invention. Referring to FIG. 3, a learning network module 308 previously trains basis functions of speech signals and noise signals by the ICA learning rule with sufficient speech signals and various noise signals and stores the basis functions of speech signals and noise signals in a memory or the like. Noise signals in the present environment are included in mike signals in an initial speech recognition standby state 301, which corresponds to mute before vocalization. During the initial speech recognition standby state 301, the learning network module 308 learns the characteristic of the present noise signals, which are input into the mike, and adapts noise basis functions to the present environment. The characteristic of noise at a non-activated speech signal is used to adjust a threshold value, which will be used for determining a speech starting point and a speech ending point.

A speech boundary-determining module 310 determines a speech starting point and a speech ending point according to determination information, which is extracted from a determination information-extracting module 303. More specifically, the determination information-extracting module 303 computes determination information for determining a speech starting point and a speech ending point by using basis functions of speech signals which are previously learned and basis functions of the noise signals, which are adapted to the present environment by the learning network module 308. And mike signals 302 are input into a speech recognition unit. A speech starting point-determining module 304 detects a speech starting point using determination information, which are extracted from the determination information-extracting module 303. A speech recognition module 305 receives speech start information from the speech staring point-determining module 304 and performs speech recognition of the mike signals 302. A speech ending point-determining module 306 detects a point where speech signals among the mike signals 302 end, by using the determination information, which is extracted from the determination information-extracting module 303, and by using the result of recognition of the speech recognition module 305. The speech starting point-determining module 304 and the speech ending module-determining module 306 determine a speech boundary by state transition algorithm.

The learning network module 308 adapts the characteristic of noise in the present environment and a determination threshold value when returned to a speech recognition standby state 370 after detection of the speech ending point.

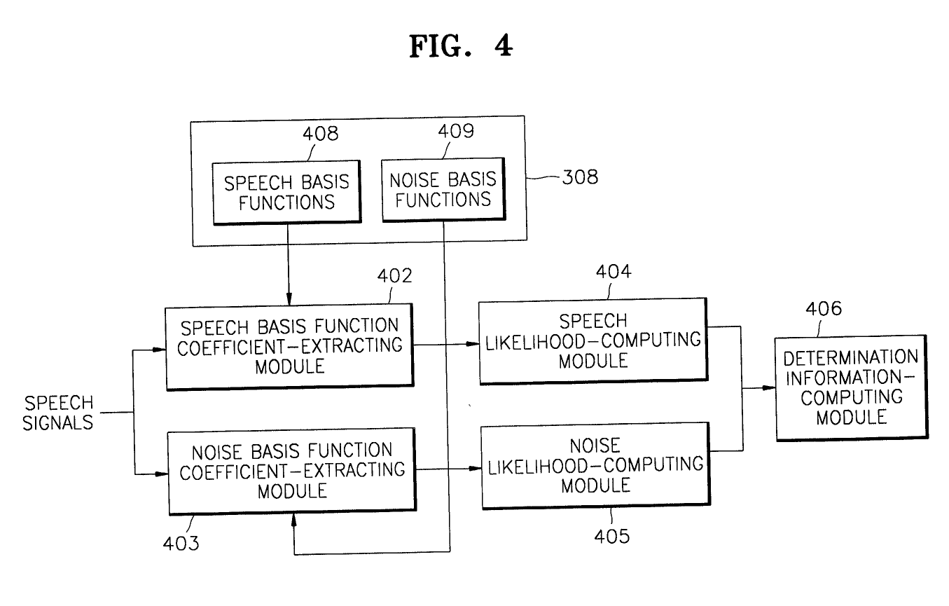

FIG. 4 is a detailed diagram of a determination information-extracting module of FIG. 3. Referring to FIG. 4, the learning network module 308 includes trained speech basis functions 408 and trained noise basis functions 409 by ICA learning rule. A speech basis function coefficient-extracting module 402 estimates a speech generation coefficient by using the speech basis functions 408 when speech signals enter into the speech recognition unit. The speech generation coefficient represents how much the speech basis functions contributes to the speech signals 401. A noise basis function coefficient-extracting module 403 also estimates a generation coefficient of noise signals by using the noise basis functions 409.

A speech likelihood-computing module 404 computes speech likelihood, which represents how much speech signals are probable, by using the speech generation coefficient as a parameter.

A noise likelihood-computing module 405 computes noise likelihood, which represents how much noise signals are probable, by using the noise generation coefficient as a parameter. The log-likelihood, logarithm of likelihood, is used in the invention.

The likelihood of the logarithm of speech signals is computed using Equation 3.

log p<x|θ>=log p(s)−log(det|Aₛ|) [Equation 3]

Here, x is a mike signal, θ is a parameter (basis function and generation coefficient or the like), s is speech, and Aₛ is a mixed matrix having speech basis function information.

The log-likelihood of noise signals is also computed using Equation 4.

logp<x|θ>=log p(n)−log(det|Aₙ|) [Equation 4]

Here, x is a mike signal, θ is a parameter (basis function and generation coefficient or the like), n is noise, and Aₙ is a mixed matrix having noise basis function information.

A determination information-computing module 406 computes parameter information to be used in determining a speech starting point and a speech ending point, by using values of likelihood, which are computed by the speech likelihood-computing module 404 and the noise likelihood-computing module 405.

Since the values of the log-likelihood of speech signals and noise signals are similar in the non-activated speech signal and the value of the log-likelihood of speech signals increases greatly at a speech activation, a difference between the value of the log-likelihood of speech signals and the value of the log-likelihood of noise signals is used as determination information.

Determination information I for searching a speech starting point is obtained as below. That is, a difference between the log-likelihood of speech signals and the log-likelihood of noise signals is normalized with respect to the difference between the log-likelihood of speech signals and the log-likelihood of noise signals at the initial non-activated speech signal and this normalized value is used as determination information. In addition to the normalized difference of log-likelihood, the log-likelihood of noise signals is used to extract determination information of a speech starting point because of the characteristic that the log-likelihood of noise signals responds to high-frequency components of speech signals.

Determination information II for searching a speech ending point is obtained as below. That is, the width of variation in a difference between the log-likelihood of speech signals and the log-likelihood of noise signals at the speech activation duration for a predetermined time duration is normalized with respect to the difference between the log-likelihood of speech signals and the log-likelihood of noise signals at the speech starting point and is used as determination information. The determination information converges into a small value when speech ends and mute begins. The result of the speech recognition unit is used with the width of variation in a difference between the two log-likelihood to compute the determination information of speech ending point detection

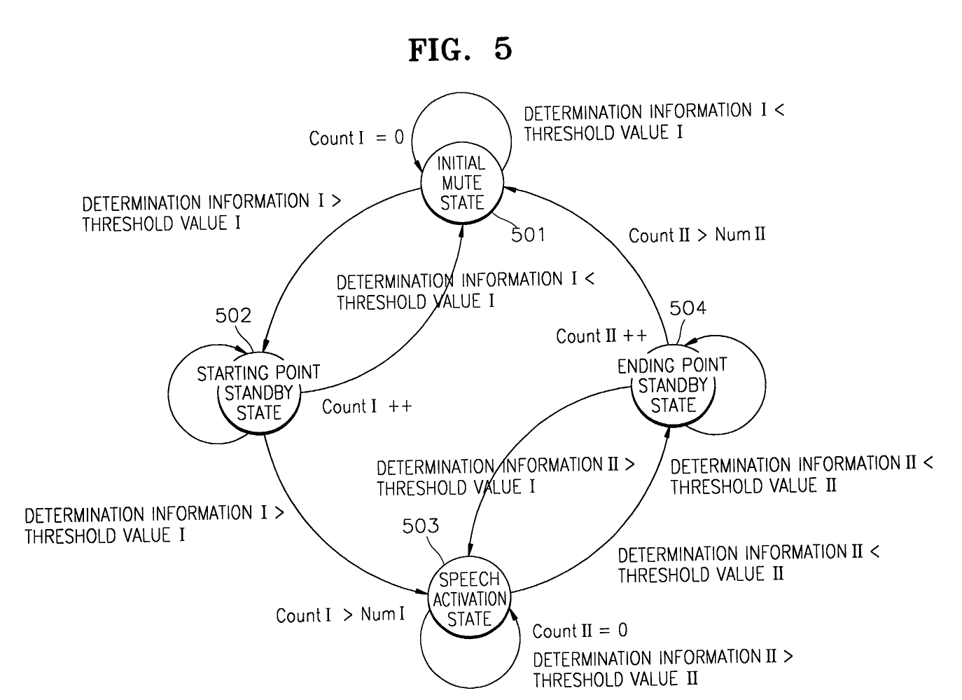

FIG. 5 illustrates state transition in which start and end of speech are determined using determination information extracted from the determination information-extracting module. Referring to FIG. 5, mike signals are input into the speech recognition unit in an initial mute state 501 having noise. When the determination information I is greater than a threshold value 1, the state is moved into a starting point standby state 502. Subsequently, the state stays in the starting point standby state 502 for more than a predetermined time and are transited into a speech activation state 503 so as to be insensitive to noise environment. In such a case, a count I is used so as to count a predetermined duration, Num I. The count I is initialized as 0 in the initial mute state 501. When the determination information I is greater than the threshold value I in the starting point standby state 502, the present state stays in the starting point standby state 502, the count I is increased by one, and it is checked whether the state stays in the starting point standby state 502 for the predetermined duration. When the count I is greater than the predetermined time Num I, that is, when the present state stays in the starting point standby state 502 for more than the predetermined time, the state is moved into the speech activation state 503. The speech starting point is a time before the time Num I at the instant that a transition into the speech activation state occurs. When the determination information I is smaller than the threshold value 1, the present state is moved again into the initial mute state 501 while staying in the starting point standby state 502, and the count I for counting the state staying time at the starting point standby state 502 is initialized again as 0. When the determination information II is greater than a threshold value II in the speech activation state 503, the present state stays in the speech activation state 503. When the determination information 11 is smaller than the threshold value 11 in the speech activation state 503, the present state is moved to an ending point standby state 504. Subsequently, the present state stays in the ending point standby state 504 only when the determination information 11 is smaller than the threshold value 11 in the ending point standby state 504, and the present state is moved into the initial mute state 501 only when the present state stays in the ending point standby state 504 more than a predetermined duration Num II. The staying at the ending point standby state 504 is counted as count II. The speech ending point is a time before the time Num II at the instant that a transition into the initial mute state occurs. When the determination information II is greater than the threshold value II while the present state stays in the ending point standby state 504, the present state is returned to the speech activation state 503. The count II is initialized as 0 when the present state is moved into the speech activation state 503.

Subsequently, when the ending point of speech is detected and the present state is moved into the initial mute state 501, detection of the starting point of speech is performed again. In such a case, the present state continuously stays when the determination information I is smaller than the threshold value I in the initial mute state 501.

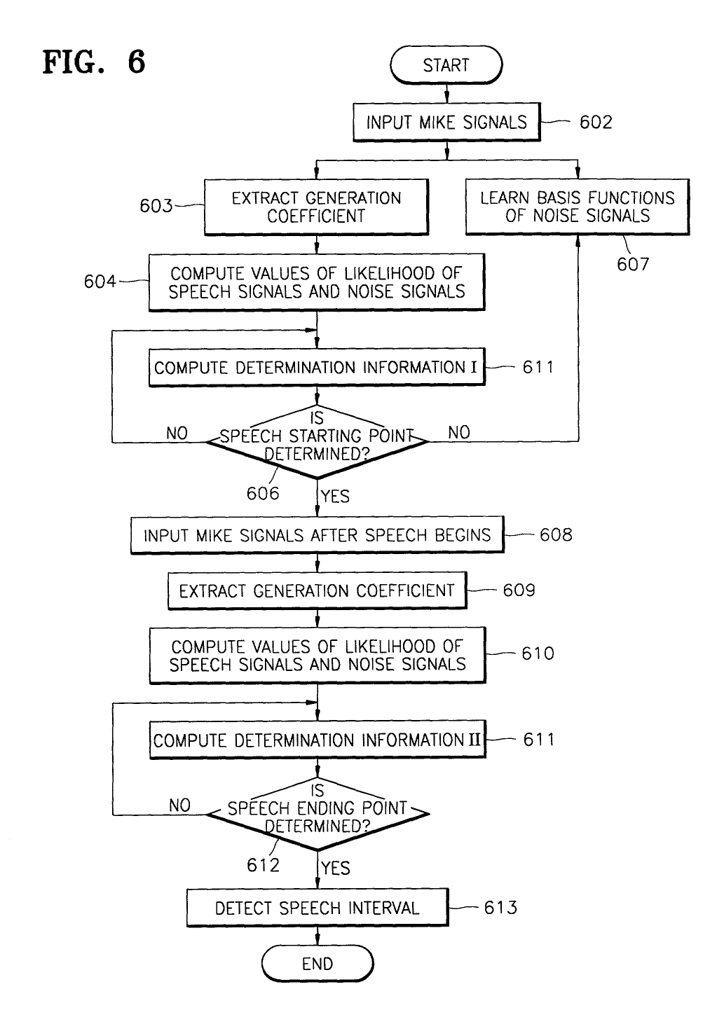

FIG. 6 is a flow chart illustrating a speech detection method according to the present invention. In step 602, mike signals enter into the speech recognition unit. In step 603, a generation coefficient is estimated from the mike signals, and in step 604, the likelihood of speech signals and noise signals are computed from the generation coefficient and basis functions. In step 605, determination information I is computed from the likelihood of speech signals and noise signals. When a speech starting point is determined from the determination information I in step 606, the mike signals are discriminated as a speech signal activation.

In step 608, the mike signals enter into the speech recognition unit when speech begins, and in step 609, a generation coefficient is estimated from speech signals so as to detect a speech ending point. In step 610, the likelihood of speech signals and noise signals are computed from the generation coefficient and basis functions.

In step 611, determination information 11 for determining a speech ending point is computed from the likelihood of speech signals and noise signals. In step 613, a starting point and an ending point are detected from speech signals when a speech ending point is determined from the determination information II in step 612.

In step 607, noise basis functions are adapted to the present noise environment by learning at a mute duration, non-activated speech signal, where noise is added, and threshold values I and 11, which are used for determining a starting point and an ending point, are adapted according to the present noise.

The speech detection apparatus and method thereof can be embodied in a computer program. The program can be realized in media used in a computer and in a common digital computer for operating the program. The program can be stored in computer readable media. The media can include magnetic media such as a floppy disk or a hard disk and optical media such as a CD-ROM or a digital video disc (DVD). Also, the program can be transmitted by carrier waves such as Internet. Also, the computer readable media is dispersed into a computer system connected by networks and can be stored as computer readable codes and implemented by a dispersion method.

As described above, speech signals can be detect without errors even in a noise environment by using basis functions, which are trained by the ICA. Further, because this method requires smaller computation than the conventional method, the present invention can be applied to a real-time system. Thus, the performance of a real-time speech recognition unit can be improved by detecting speech signals robustly even in a high noise environment.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A speech detection method in a noise environment, the method comprising the steps of:
training basis functions of speech signals and basis functions of noise signals according to a predetermined learning rule;
adapting the basis functions of noise signals to the present environment by using the characteristic of noise signals, which are input into a mike;
extracting determination information for detection speech activation from the basis functions of speech signals and the basis functions of noise signals; and
detecting a speech starting point and a speech ending point of mike signals, which come into a speech recognition unit, from the determination information.

2. The method of claim 1, wherein the predetermined learning rule is independent component analysis (ICA).

3. The method of claim 1, wherein the step of extracting determination information comprises the steps of:
estimating speech and noise generation coefficients from the basis functions of noise signals and the basis functions of speech signals;
computing values of likelihood of speech signals and noise signals from the speech and noise generation coefficients; and
computing speech activation-determining information from a difference between the likelihood of speech signals and the value of the likelihood of noise signals.

4. The method of claim 3, wherein the likelihood of speech signals is computed using Equation;
log p<x|θ>=log p(s)−log(det|Aₛ|),
where x is a mike signal, θ is a parameter, s is speech, and Aₛ is a mixing matrix having speech basis function information.

5. The method of claim 1, wherein the determination information for detecting a speech starting point is a value in which a difference between the log-likelihood of speech signals and the log-likelihood of noise signals is normalized with respect to the difference between the log-likelihood of speech signals and the log-likelihood of noise signals at the initial non-activated speech signal.

6. The method of claim 1, wherein a value in which a difference between the log-likelihood of speech signals and the log-likelihood of noise signals is normalized with respect to the difference between the log-likelihood of speech signals and the log-likelihood of noise signals at the initial non-activated speech signal, and the log-likelihood of noise signals is used as the determination information for detecting a speech starting point.

7. The method of claim 1, wherein the determination information for detecting a speech ending point is a value in which the width of variation in a difference between the log-likelihood of speech signals and the log-likelihood of noise signals for a predetermined duration is normalized with respect to the difference between the log-likelihood of speech signals and the log-likelihood of noise signals at the initial non-activated speech signal.

8. The method of claim 1, wherein mike signals are input into a speech recognition unit in an initial mute state having noise, the state is moved into a starting point standby state when a speech starting point-determining information is greater than a first threshold value, the state is moved into a speech activation state when the speech starting point-determining information is greater than the first threshold value for a predetermined duration, the state is returned to the initial mute state when the speech starting point-determining information is not greater than the first threshold value for a predetermined duration, the state is moved into a speech ending point standby state when a speech ending point-determining information is smaller than a second threshold value in the speech activation state, the state is moved into the initial mute state when the state stays in the speech ending point standby state for more than a predetermined duration, and the state is returned to the speech activation the speech ending point-determining information is not smaller than the second threshold value for a predetermined duration, in the step of detecting a speech starting point and a speech ending point.

9. The method of claim 8, wherein the first and second threshold values are determined according to the circumstance of the present noise.

10. A speech detection apparatus for detecting a speech boundary in a noise environment, the apparatus comprising:
a learning network means, which trains basis functions of speech signals and basis functions of noise signals according to a predetermined learning rule and adapts the basis functions of noise signals to the present environment by using the characteristic of noise signals, which input into a mike;
a determination information-extracting means, which extracts determination information of the mike signal from the basis functions of speech signals and the basis functions of noise signals; and
a speech boundary-determining means, which detects a speech starting point and a speech ending point of mike signals, which are input into a speech recognition unit, from the determination information of the mike signal.

11. The apparatus of claim 10, wherein the determination information-extracting means comprises:
a speech basis function coefficient-extracting module, which estimates a speech generation coefficient from the basis functions of speech signals;
a noise basis function coefficient-extracting module, which estimates a noise generation coefficient from the basis functions of noise signals;
a speech likelihood-computing module, which computes the likelihood of speech signals from the speech generation coefficient;
a noise likelihood-computing module, which computes the likelihood of noise signals from the noise generation coefficient; and
a determination information-computing module, which computes speech determination information according to a difference between the likelihood of speech signals and the likelihood of noise signals.

12. A computer readable medium in a computer system having a processor, including a program comprising steps of:
previously training basis functions of speech signals and basis functions of noise signals according to a predetermined learning rule;
adapting the basis functions of noise signals to the present environment by using the characteristic of noise signals, which are input into a mike;
extracting determination information of mike signal from the basis functions of speech signals and the basis functions of noise signals; and
detecting a speech starting point and a speech ending point of mike signals, which are input into a speech recognition unit, from the determination information.
